(19) United States
(12) Patent Application Publication
(10) Pub. No.: US 2016/0245107 A1
(43) Pub. Date: Aug. 25, 2016

(54) TURBINE BLADE AND GAS TURBINE

(71) Applicant: SIEMENS AKTIENGESELLSCHAFT, München (DE)

(72) Inventors: Sascha Dungs, Wesel (DE); Karsten Kolk, Mulheim a.d. Ruhr (DE); Peter Schröder, Essen (DE)

(73) Assignee: Siemens Aktiengesellschaft, Munich (DE)

(21) Appl. No.: 15/025,725

(22) PCT Filed: Sep. 4, 2014
(86) PCT No.: PCT/EP2014/068828

§ 371 Date: Mar. 29, 2016

(30) Foreign Application Priority Data
Oct. 10, 2013 (EP) 13187992.6

(51) Int. Cl. F01D 11/00; F01D 5/14; F01D 5/22

(52) U.S. Cl. CPC F01D 11/008; F01D 5/225; F01D 5/147; F05D 2220/32; F05D 2240/24; F05D 2230/10; F05D 2260/30

(57) ABSTRACT

A turbine blade with a turbine blade aerofoil, a turbine blade root and a turbine blade platform located between the turbine blade aerofoil and the turbine blade root and having, in its underside, an insertion groove for the insertion of a sealing plate; the sealing plate can be secured by a securing element supported on the turbine blade platform, and the turbine blade platform has a material cut-out with two support edges located opposite each other in such a way that the securing element can be secured on both sides to the turbine blade across the axial extension of the turbine blade root.

### CROSS REFERENCE TO RELATED APPLICATIONS

This application is the U.S. National Stage of International Application No. PCT/EP2014/068828 filed Sep. 4, 2014, and claims the benefit thereof. The International Application claims the benefit of European Application No. EP13187992 filed Oct. 10, 2013. All of the applications are incorporated by reference herein in their entirety.

### FIELD OF INVENTION

The invention relates to a turbine blade having a turbine blade airfoil, a turbine blade root and, arranged between the turbine blade airfoil and the turbine blade root, a turbine blade platform which has, on its underside, an insertion slot for inserting a seal plate, wherein the seal plate can be secured by means of a securing element supported by the turbine blade platform.

The invention also relates to a gas turbine having a multiplicity of turbine blades and having a turbine rotor to which the turbine blades are attached in each case by means of a turbine blade root.

### BACKGROUND OF INVENTION

Generic turbine blades are well known from the prior art. The respective turbine blade has a turbine blade airfoil and a turbine blade root. The latter allows it to be immobilized in a turbine rotor slot corresponding formed on a turbine rotor. To that end, the respective turbine blade with the turbine blade root is pushed, in the axial insertion direction which is aligned with the axis of rotation of the turbine rotor, into the corresponding turbine rotor slot and is held therein. In a transition region between the turbine blade root and a turbine blade airfoil, the turbine blade has a turbine blade platform for supporting the turbine blade on the turbine rotor.

On the insertion side of the turbine rotor, the turbine blade roots and the turbine rotor slots are clad with seal plates in order to separate a cooling air region, on the turbine blade root side, from an outer hot air region, in particular of a gas turbine. In this context, these seal plates are immobilized on one hand against an insertion slot provided in the respective turbine blade platform and on the other hand against a retaining slot machined into the turbine rotor. In order, in particular, to secure the circumferential position of these seal plates, the seal plates are additionally also secured to the turbine blade platform by a securing means. This securing means comprises at least one flexible securing plate element which can engage, with one of its ends, in a gap formed jointly by two immediately adjacent turbine blades, when it is bent accordingly. This securing means then prevents unintended rotation of the seal plates in the circumferential direction of the turbine rotor.

### SUMMARY OF INVENTION

The invention has the object of further developing generic turbine blades.

The object of the invention is achieved with a turbine blade having a turbine blade airfoil, a turbine blade root and, arranged between the turbine blade airfoil and the turbine blade root, a turbine blade platform which has, on its underside, an insertion slot for inserting a seal plate, wherein the seal plate can be secured by means of a securing element supported by the turbine blade platform, and wherein the turbine blade platform has a cutout with two bearing edges which lie opposite one another such that the securing element can be immobilized transversely to the axial extent of the turbine blade root on both sides of the turbine blade.

According to the invention, the turbine blade has, on the turbine blade platform, a cutout for immobilizing on both sides, and thus also for securing on both sides, the securing element in the circumferential direction of a turbine rotor or of a platform ring element which is configured on the underside of the turbine blade platform, in particular at least partially on a web of the turbine blade platform oriented toward the turbine rotor, such that the securing element is immobilized in both directions against bearing edges of the cutout.

Such a platform ring element consists of a multiplicity of turbine blades which are arranged adjacent to one another around an axis of rotation of a turbine rotor.

Hitherto, the securing element could be secured only on one side against a lateral rim contour of the turbine blade platform, such that two mutually corresponding turbine blades were always required in order to be able to secure the securing element in the circumferential direction on both sides against the turbine blade platform within the meaning of the invention. On account of tolerances imposed thereby, the securing element can often be secured only imprecisely on the turbine blade platforms of the turbine blades.

The securing element in particular comprises a flexible plate strip element which is bent on one hand in a known manner through longitudinal slits made in the seal plate. If the seal plate is properly mounted, one end of this flexible plate strip element is bent into the cutout such that this end immobilizes the flexible plate strip element against the turbine blade platform on both sides with respect to the circumferential direction.

It has been found that the securing element can be installed most advantageously if it can be immobilized, and thus secured, directly on the turbine blade and specifically in the region of the underside of the turbine blade platform.

Particularly precisely, it is possible in the present case for a cold gap, which must be maintained, to be set between the securing element and the turbine blade platform, since this cold gap need be set in each case only with respect to a single turbine blade and no longer with respect to two such turbine blades. A correctly set cold gap is important in this respect in order that, during operation of a gas turbine or the like, the securing element does not bear the seal plate.

In this respect, if the cutout according to the invention is formed on the turbine blade platform, the securing element can be secured with greater precision, and as a result also a gas turbine or the like can be operated with greater operational reliability.

Thus, the object of the invention is also achieved with a gas turbine having a multiplicity of turbine blades and a turbine rotor to which the turbine blades are attached in each case by means of a turbine blade root, wherein the gas turbine comprises turbine blades in accordance with one of the features described here.

Another embodiment variant thus also provides that the cutout is created in the turbine blade platform.

Alternatively, the cutout can also be created on the turbine blade platform if there is arranged, on the underside of the turbine blade platform, an additional material accumulation in which the cutout is created. If, additionally, such a material accumulation is affixed to the underside of the turbine blade platform, the structure of the turbine blade platform is advantageously not negatively affected by a weakening of the material caused by the cutout.

The material accumulation can be affixed to the turbine blade platform in a structurally simple manner by being cast on.

The cutout can be configured in a structurally simple manner with the aid of the material accumulation if the material accumulation is arranged radially below and axially next to the insertion slot. In this context, the cutout is located at least partially—as seen in the radial direction—below this insertion slot and - as seen in the axial direction—next to this insertion slot.

Within the meaning of the invention, the radial direction extends in the direction of the longitudinal extent of the turbine blade airfoil, whereas the axial direction extends in the direction of the longitudinal extent of the turbine blade root, or in line with an axis of rotation of a turbine rotor.

If the cutout is arranged transversely with respect to the axial extent of the turbine blade root and centrally on the turbine blade platform, the cutout can be arranged directly below the turbine blade airfoil, this region of the turbine blade platforms being particularly stable.

The cutout can be produced more simply, in terms of construction, on the turbine blade platform if the cutout has a breadth by means of which it is possible to ensure operationally secure covering with the securing element.

The securing element can particularly easily be bent into the cutout if the cutout is arranged above that end of the turbine blade root end that is furthest from the turbine blade platform.

In this context, the furthest end is generally the lower end of the turbine blade.

Of course, the cutout can have almost any shape. It is however advantageous if the cutout is triangular. This makes it easy—from a production point of view—to create the cutout.

Simplified installation of the securing element can be achieved if the two bearing edges form a recess space which is open downward.

Advantageously, the two bearing edges enclose an opening angle of less than 170° or less than 100°, such that forces acting from the securing element on the turbine blade platforms can be sufficiently well transmitted.

For that reason, it is also advantageous if the bearing edges enclose an opening angle of greater than 30°.

The cutout can be created simply, in terms of process technology, on the underside of the turbine blade platform if the bearing edges are arranged to give a recess space that narrows to a point in the direction of the turbine blade airfoil.

The securing element can be very precisely immobilized on the turbine blade platform if the bearing edges are machined mechanically.

The operationally secure immobilization of the securing element on the turbine blade platform can be further improved if the bearing edges are made broad enough that it is possible to ensure operationally secure covering with the securing element.

In this context, the breadth of the bearing edges extends in the axial direction of the turbine blade root.

Advantageously, in this context, the bearing edges are at least as broad as the thickness of the securing plate element of the securing element. Thus, the securing element with its end can be well taken up by the cutout, without projecting axially beyond the cutout.

The present invention makes it possible to secure an arrangement of turbine blade, seal plate and securing element particularly well against circumferential displacement, in particular of the seal plate.

In this context, the already known and proven securing method can be adopted with the securing element.

### BRIEF DESCRIPTION OF THE DRAWINGS

Embodiments of turbine blades according to the invention are explained below with reference to the appended schematic drawings. In the drawings:

FIG. 1 shows, schematically, a perspective view of a first inventive turbine blade having, arranged in the region of its turbine blade platform, a cutout with two mutually opposing bearing edges for securing a securing plate on both sides,

FIG. 2 shows, schematically, a detail view of the cutout shown in FIG. 1,

FIG. 3 shows, schematically, a perspective view of another inventive turbine blade having, provided in the region of its turbine blade platform, a material accumulation, on which material accumulation is created a cutout with two mutually opposing bearing edges for securing a securing plate on both sides,

FIG. 4 shows, schematically, a detail view of the cutout, shown in FIG. 3, created in the material accumulation,

FIG. 5 shows, schematically, a side view of the turbine blade shown in FIGS. 3 and 4, and

FIG. 6 shows, schematically, a view of a seal plate having a securing element affixed thereto,

FIG. 7 shows, schematically, a diagrammatic assembly view of a securing element, the end of which is secured in a cutout created on the underside of a turbine blade platform.

### DETAILED DESCRIPTION OF INVENTION

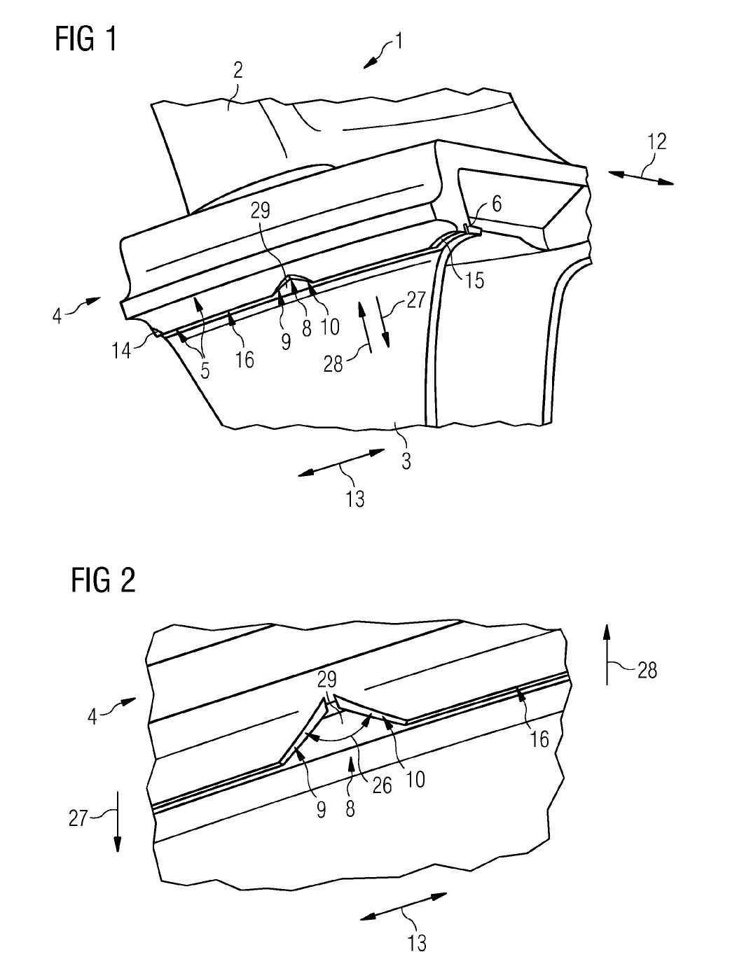

The first exemplary embodiment shown in FIGS. 1 and 2 shows a partially illustrated turbine blade 1 having a turbine blade airfoil 2, a turbine blade root 3 and a turbine blade platform 4 arranged between the turbine blade airfoil 2 and the turbine blade root 3.

The turbine blade platform 4 has, on its underside 5, an insertion slot 6 for inserting a seal plate 7 (see FIG. 6), wherein, according to the invention, the turbine blade platform 4 has a cutout 8 with two bearing edges 9 and 10 which lie opposite one another such that a securing element 11 for securing the seal plate 7 can be immobilized transversely to the axial extent 12 of the turbine blade root 3 on both sides of the turbine blade 1. This makes it possible for the seal plate 7 to be secured in the circumferential direction 13 on both sides on just a single turbine blade 1.

Moreover, it is substantially easier to produce such a cutout 8 than to machine, on the turbine blade platform 4, two rim regions 14 and 15, each of which can however support the securing element 11 on just one side. Hitherto, it has always been necessary to have two immediately adjacent turbine blades 1 which, on their respective turbine blade platforms 4, need to be machined with a corresponding level of precision in order to be able to secure the securing element 11 in a precise and operationally secure manner.

Of course, the present cutout 8 can have a great variety of shapes.

According to the illustrations of FIGS. 1 and 2, the cutout 8 is created directly in the turbine blade platform 4. That means that the cutout 8 is located entirely behind the lower outer edge 16 of the turbine blade platform 4 or behind the lower outer edge 16 of a web 17, running from the rim region 14 to the rim region 15, of the turbine blade platform 4, and in particular terminates at this outer edge 16. In this context, the cutout 8 is at least partially at the same height as, and thus directly—as seen in the axial extent 12—axially next to the insertion slot 6 into which the seal plate 7 is inserted in the case of proper assembly.

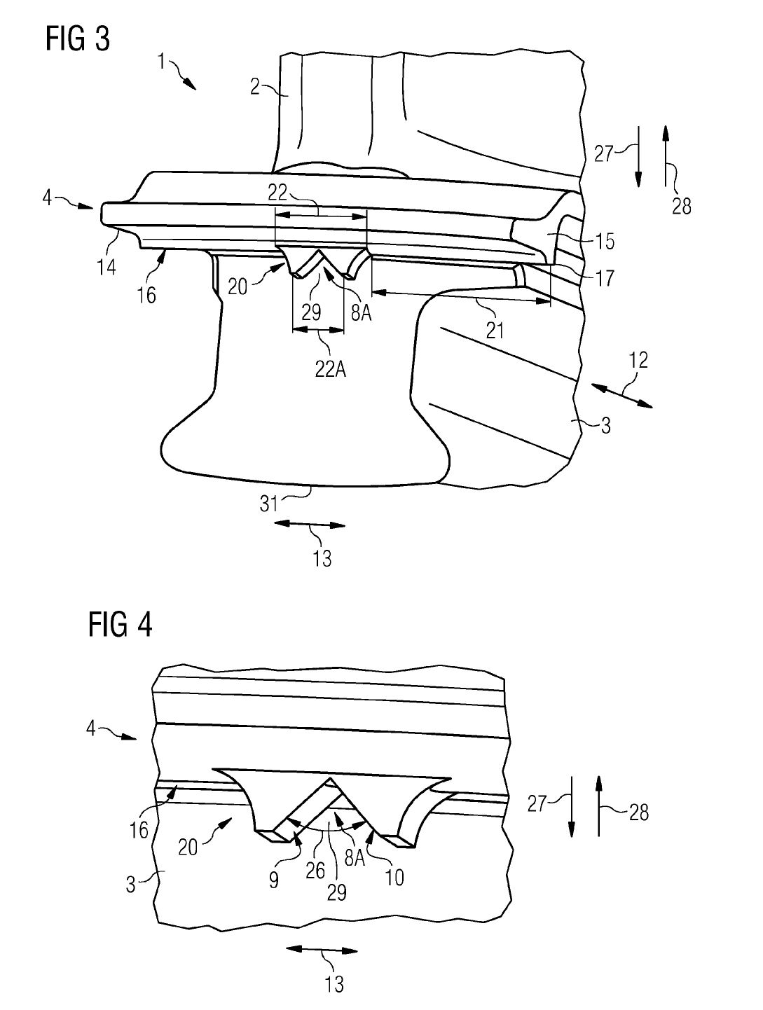

According to the illustrations of FIGS. 3 to 5, the cutout 8 is created in a material accumulation 20 additionally affixed beneath the turbine blade platform 4. In this exemplary embodiment, the material accumulation 20 is located radially beneath and axially next to the insertion slot 6, such that the turbine blade platform 4 is not weakened structurally by the cutout 8A.

The material accumulation 20 is a raised portion which is present partially beneath the turbine blade platform 4 and is spaced apart on both sides from the rim regions 14 and 15 by a distance 21 and is thus not to be mistaken for the web 17 running on the underside 5 of the turbine blade platform 4 continuously from the rim region 14 to the rim region 15 or vice versa.

The respective distance 21 (here illustrated and numbered only by way of example) between the material accumulation 20, but also between the cutouts 8 or, respectively, 8A, and one of the rim regions 14 or 15 is substantially greater than, in particular twice as great as, the length 22 of the material accumulation 20 or of the opening length 22A of the cutouts 8 or, respectively, 8A transversely with respect to the axial extent 12 of the turbine blade root 3.

In this context, the cutout 8A can be machined as far as into the web 17; however, this need not necessarily be so, in which latter variant the web 17 is not weakened by the tip of the cutout 8A.

In the exemplary embodiments shown here by way of example, both cutouts 8 or, respectively, 8A are triangular.

Moreover, the cutouts 8 or, respectively, 8A are arranged in each case transversely with respect to the axial extent 12 of the turbine blade root 3 and centrally on the turbine blade platform 4 such that the turbine blade root 3 can still be symmetric transversely with respect to its axial extent 12.

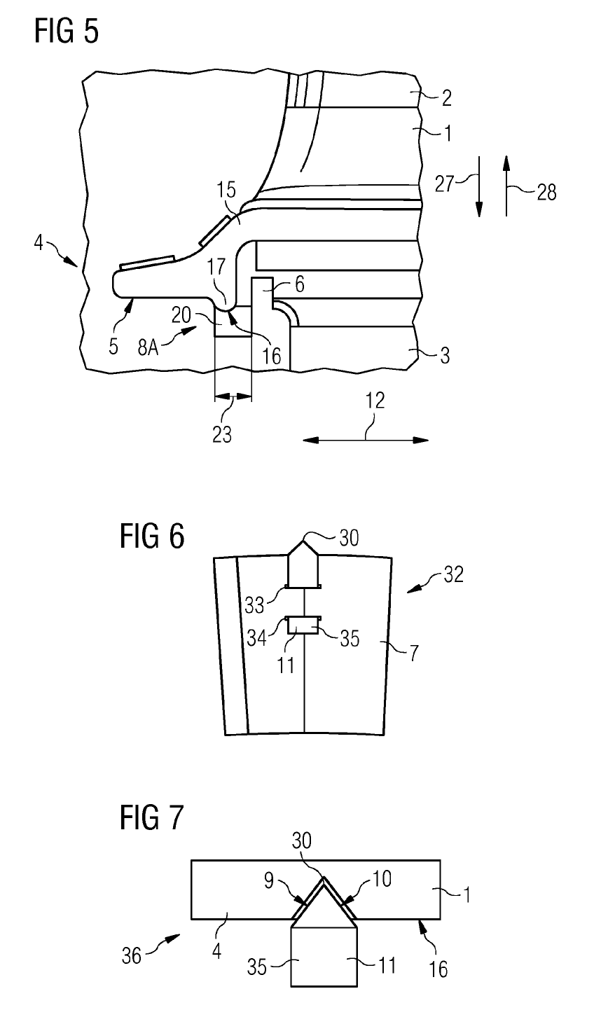

Furthermore, the cutouts 8 or, respectively, 8A each have a breadth 23 by means of which it is possible to ensure operationally secure covering with the securing element 11 (see by way of example FIG. 5).

In this respect, the cutouts 8 or, respectively, 8A also each have the two bearing edges 9 and 10 against which the securing element 11 can bear on both sides and which are made broad enough that it is possible to ensure operationally secure covering with the securing element 11.

The two bearing edges 9 and 10 enclose an opening angle 26 and in that context form a recess space 29 which is open downward, that is to say in the radial direction 27 toward the turbine blade root 3, and which narrows to a point upward, that is to say in the opposite radial direction 28 toward the turbine blade platform 4, and into which the tip 30 (see FIG. 6 or 7) of the securing element 11 can be bent.

The cutout 8 or, respectively, 8A can in each case be arranged above that end 31 of the turbine blade root end 3 that is furthest from the turbine blade platform 4, such that the seal plate 7 can be secured to the relevant cutout 8 or, respectively, 8A of the turbine blade platform 4 in a structurally simple manner with the aid of the securing element 11.

Such a seal plate 7 is shown by way of example in FIG. 6. In its upper region 32, it has two slits 33 and 34 which are spaced apart from one another and through which the securing element 11, configured as a plate element 35, is inserted in a manner known per se. In this context, the slits 33 and 34 are arranged one above the other and run with their respective longitudinal sides (here not numbered explicitly) transversely with respect to the axial extent 12 of the turbine blade root 3, such that the securing element 11 runs radially in line with the turbine blade airfoil 2.

In this respect, the tip 30 of the securing element 11 can easily be bent into the downward-opening recess space 29 and can be immobilized or secured on the turbine blade platform 4.

An assembly state 36 relating to this is shown in the illustration of FIG. 7, in which the tip 30 of the securing element 11 is arranged in the final assembly in the cutout 8 or 8A.

Although the invention has been described and illustrated in more detail by way of the preferred exemplary embodiments, the invention is not restricted by these disclosed exemplary embodiments and other variations can be derived herefrom by a person skilled in the art without departing from the scope of protection of the invention.

1. A turbine blade having
a turbine blade airfoil, a turbine blade root and, arranged between the turbine blade airfoil and the turbine blade root, a turbine blade platform which has, on its underside, an insertion slot for inserting a seal plate,
wherein the seal plate can be secured by means of a securing element supported by the turbine blade platform, and
wherein the turbine blade platform has a cutout with two bearing edges which lie opposite one another such that the securing element can be immobilized transversely to the axial extent of the turbine blade root on both sides of the turbine blade.

2. The turbine blade as claimed in claim 1,
wherein the cutout is created in the turbine blade platform.

3. The turbine blade as claimed in claim 1,
wherein there is arranged, on the underside of the turbine blade platform, an additional material accumulation in which the cutout is created.

4. The turbine blade as claimed in claim 3,
wherein the material accumulation is arranged radially below and axially next to the insertion slot.

5. The turbine blade as claimed in claim 1,
wherein the cutout is arranged transversely with respect to the axial extent of the turbine blade root and centrally on the turbine blade platform.

6. The turbine blade as claimed in claim 1,
wherein the cutout has a breadth by means of which it is possible to ensure operationally secure covering with the securing element.

7. The turbine blade as claimed in claim 1,
wherein the cutout is arranged above that end of the turbine blade root end that is furthest from the turbine blade platform.

8. The turbine blade as claimed in claim 1,
wherein the cutout is triangular.

9. The turbine blade as claimed in claim 1,
wherein the two bearing edges form a recess space which is open downward.

10. The turbine blade as claimed in claim 1,
wherein the two bearing edges enclose an opening angle of less than 170° or less than 100°.

11. The turbine blade as claimed in claim 1,
wherein the bearing edges enclose an opening angle of greater than 30°.

12. The turbine blade as claimed in claim 1,
wherein the bearing edges are arranged to give a recess space that narrows to a point in the direction of the turbine blade airfoil.

13. The turbine blade as claimed in claim 1,
wherein the bearing edges are machined mechanically.

14. The turbine blade as claimed in claim 1,
wherein the bearing edges are made broad enough that it is possible to ensure operationally secure covering with the securing element.

15. A gas turbine having
a multiplicity of turbine blades and having a turbine rotor to which the turbine blades are attached in each case by means of a turbine blade root,
wherein the gas turbine comprises turbine blades as claimed in claim 1.
